(19) United States
(12) Patent Application Publication
(10) Pub. No.: US 2014/0132467 A1
(43) Pub. Date: May 15, 2014

(54) ANTENNA USING SLOT IN MOBILE TERMINAL

(71) Applicant: Samsung Electronics Co., Ltd., Gyeonggi-do (KR)

(72) Inventors: Hoon PARK, Seoul (KR); Yongsoo Kwak, Gyeonggi-do (KR); Hosaeng Kim, Gyeonggi-do (KR); Joonho Byun, Gyeonggi-do (KR); Sangjin Eom, Gyeonggi-do (KR); Seongtae Jeong, Gyeonggi-do (KR)

(73) Assignee: Samsung Electronics Co., Ltd., Gyeonggi-do (KR)

(21) Appl. No.: 14/073,419

(22) Filed: Nov. 6, 2013

(30) Foreign Application Priority Data
Nov. 9, 2012 (KR) 10-2012-0126658

(51) Int. Cl. H01Q 1/52

(52) U.S. Cl. CPC H01Q 1/52
USPC 343/767; 343/770

(57) ABSTRACT

An antenna using a slot formed by assembling a mobile terminal case and a metal structure (e.g., a bracket), is disclosed. The antenna reduces deterioration of antenna performance resulting from frequency interference or electromagnetic interference. The antenna can be used in various frequency bands.

### PRIORITY

This application claims priority under 35 U.S.C. §119(a) to a Korean patent application filed on Nov. 9, 2012 in the Korean Intellectual Property Office and assigned Serial No.10-2012-0126658, the entire disclosure of which is incorporated herein by reference.

### BACKGROUND

1. Field of the Invention

The present invention relates generally to an antenna in a mobile terminal that enhances an antenna performance by using a slot.

2. Description of the Related Art

A mobile terminal (e.g., a mobile phone, a Digital Media Broadcasting (DMB) terminal, a Personal Digital Assistant (PDA), a Moving Picture experts group layer-3 (MP3) player) has been widely used, and such a mobile terminal provides wireless communication with another terminal. The mobile terminal can communicate with another terminal through various frequency bands. In such a wireless communication, the mobile terminal requires one or more antennas (e.g., a Global Positioning System (GPS) antenna, a WiFi or WiMAX antenna, an antenna for both transmission and reception, and an antenna for transmission or reception only).

When a metal component exists in the vicinity of the antenna, a scattering effect, electromagnetic interference, and/or a confinement phenomenon occurs due to the metal component, and thus the performance of the antenna is sharply deteriorated. In a conventional mobile terminal, the electromagnetic interference can be reduced because there is sufficient space for the antenna. The sufficient separation distance can be secured between the antenna and peripheral metal parts. Thus, there is no difficulty in achieving a reliable antenna performance while reducing electromagnetic interference.

However, a demand for a small mobile terminal having a small thickness has recently been on the rise. In order to provide a variety of services in the mobile terminal, one or more antennas are necessary. In order to satisfy such a demand, mobile terminal production companies have made an effort to reduce the size of the antenna for the mobile terminal.

Since the conventional antenna technology does not satisfy these rapidly changing consumer demands, an antenna implementing high performance, even in a mobile terminal having insufficient space, is needed.

### SUMMARY

The present invention has been made to address at least the disadvantages and problems described above, and to provide at least the advantages described below. Accordingly, an aspect of the present invention provides an antenna in a mobile terminal having limited space and provides an antenna using a slot formed by assembling a mobile terminal case, a metal fence, and a component (e.g., a bracket). Such an antenna can be used in various frequency bands.

Another aspect of the present invention provides an antenna in a mobile terminal that prevents deterioration of antenna performance due to frequency interference or electromagnetic interference.

In accordance with an aspect of the present invention, an antenna in a mobile terminal includes a slot formed in a mobile terminal by assembling a mobile terminal case and a metal structure, a metal fence disposed at a side surface adjacent to the metal structure and the slot, and a feeding pattern for supplying power to the antenna.

### BRIEF DESCRIPTION OF THE DRAWINGS

The aspects, features and advantages of the present invention will be more apparent from the following detailed description taken in conjunction with the accompanying drawings, in which:

FIG. 1 illustrates an open slot and a slot path formed in a bracket according to an embodiment of the present invention;

FIG. 2 is a perspective view illustrating an assembly of a bracket, slot, and metal fence according to an embodiment of the present invention;

FIG. 3 is an exploded perspective view illustrating an antenna assembly structure when assembling a case, a bracket, and a metal fence of a mobile terminal according to an embodiment of the present invention;

FIG. 4 illustrates various lengths and shapes of an open slot and a slot path formed in a bracket according to an embodiment of the present invention;

FIG. 5 illustrates a change in a position of an open slot and a size of a slot path;

FIG. 6 illustrates various positions of an open slot and various lengths and sizes of a slot path formed in a bracket, according to another embodiment of the present invention;

FIG. 7 is a perspective view illustrating an assembly of a bracket, slot, and metal fence according to another embodiment of the present invention;

FIG. 8 illustrates an antenna adjacent to another antenna having a different frequency according to an embodiment of the present invention;

FIG. 9 illustrates various positions of an open slot according to a desired frequency band according to an embodiment of the present invention;

FIG. 10 illustrates an antenna structure using a distance change between a metal fence and an open slot and a slot;

FIG. 11 illustrates an open slot, a slot path, and a metal fence that can be positioned at various locations;

FIG. 12 illustrates various positions of an open slot according to a desired frequency band in relation to FIG. 6, according to another embodiment of the present invention;

FIG. 13 illustrates an antenna structure using a distance change between a metal fence and an open slot and a slot path;

FIG. 14 illustrates an open slot, a slot path, and a metal fence that can be positioned at various locations; and

FIG. 15 illustrates a change in a shape and a length of a slot path according to an embodiment of the present invention.

### DETAILED DESCRIPTION OF EMBODIMENTS OF THE PRESENT INVENTION

The following description with reference to the accompanying drawings is provided to assist in a comprehensive understanding of embodiments of the invention as defined by the claims and their equivalents. It includes various specific details to assist in that understanding but these are to be regarded as mere examples. Accordingly, those of ordinary skill in the art will recognize that various changes and modifications of the embodiments described herein can be made without departing from the scope and spirit of the disclosure. In addition, descriptions of well-known functions and constructions may be omitted for clarity and conciseness.

The terms and words used in the following description and claims are not limited to their dictionary meanings, but, are merely used to enable a clear and consistent understanding of the invention. Accordingly, it should be apparent to those skilled in the art that the following description of embodiments of the present invention is provided for illustration purpose only and not for the purposes of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

A slot indicates space that is removed or empty in an antenna radiator, and an antenna using the slot is generally referred to as a slot antenna. An area of the antenna radiator varies according to a length and/or a size of the slot. Thus, a surface current density flowing to the radiator increases as a size of the slot increases and a resonant frequency of the antenna is lowered. Therefore, a desired resonant frequency can be adjusted according to the length and/or the size of the slot. Further, the slot may have various shapes and cross-sections, such as a quadrangle, oval, or circle, and one or more slot may be used. The meaning of the slot in the present embodiment includes both an open slot and a slot path.

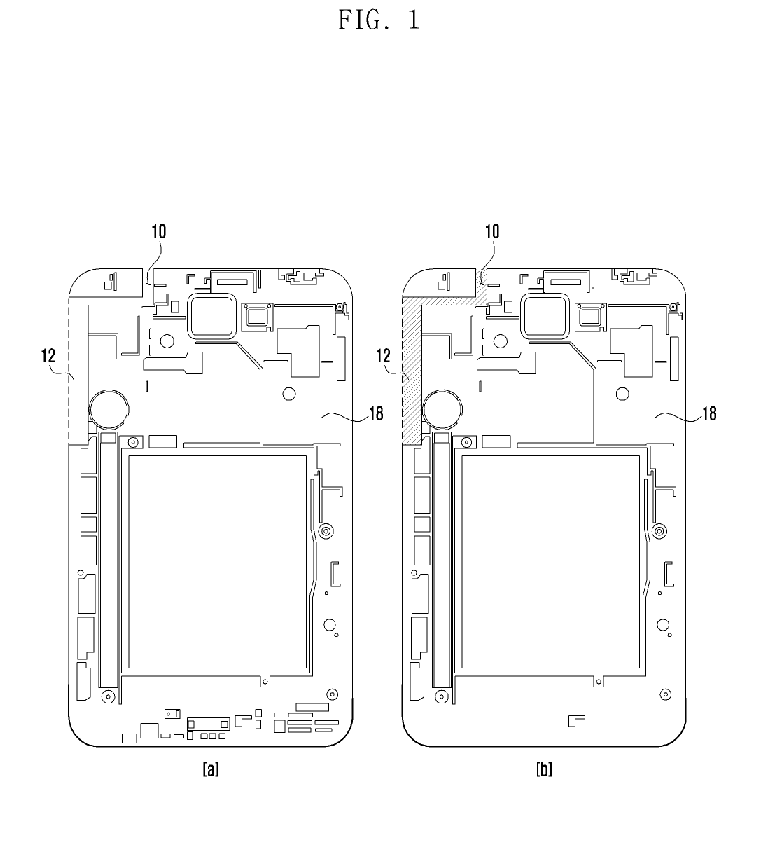

FIG. 1 illustrates an open slot and a slot path formed in a bracket according to an embodiment of the present invention.

Referring to FIG. 1, an open slot 10 and a slot path 12 are formed in a bracket 18. FIGS. 1a and 1b illustrate an example where the open slot 10 and the slot path 12 are formed in an upper end portion of the left side of the bracket 18. The bracket 18 is generally made of metal, plastic or a combination thereof as shown in FIG. 1b. Further, the inside of the open slot 10 and the slot path 12 may be filled with a dielectric substance or a magnetic substance as needed.

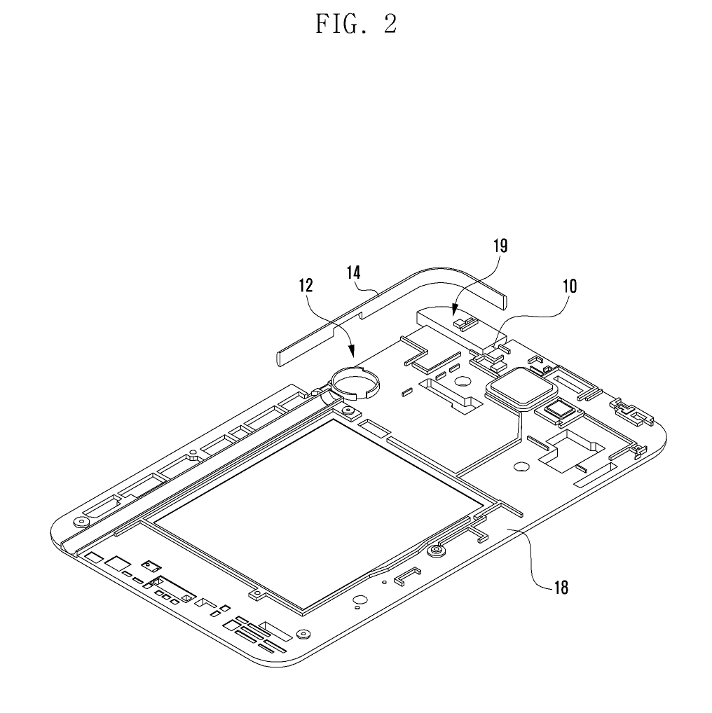

In order to obtain a desired frequency band, to avoid frequency interference from an adjacent antenna, and to reduce an electromagnetic influence of peripheral electrical parts, a position, shape, width, and length of the open slot 10 and the slot path 12 may be changed. FIG. 2 is a perspective view illustrating an assembly of a bracket, slot, and a metal fence according to an embodiment of the present invention.

FIG. 2 illustrates an embodiment having the slot path 12 formed in a certain area of the bracket 18. The open slot 10 and the slot path 12 exist in the bracket 18 and the metal fence 14 is provided adjacent to the slot. The metal fence 14 functions as an area of an antenna in association with a surface current density. Further, the metal fence 14 electrically connects the separate bracket 19 to the bracket 18. When the slot is formed, as shown in the FIG. 2, a piece of bracket 19 is separated from the bracket 18. In the present embodiment, a position of the slot is not limited to an upper end corner of the bracket 18, as shown in FIG. 2. The slot may be positioned at a lower end portion or various other locations of the bracket 18, as desired.

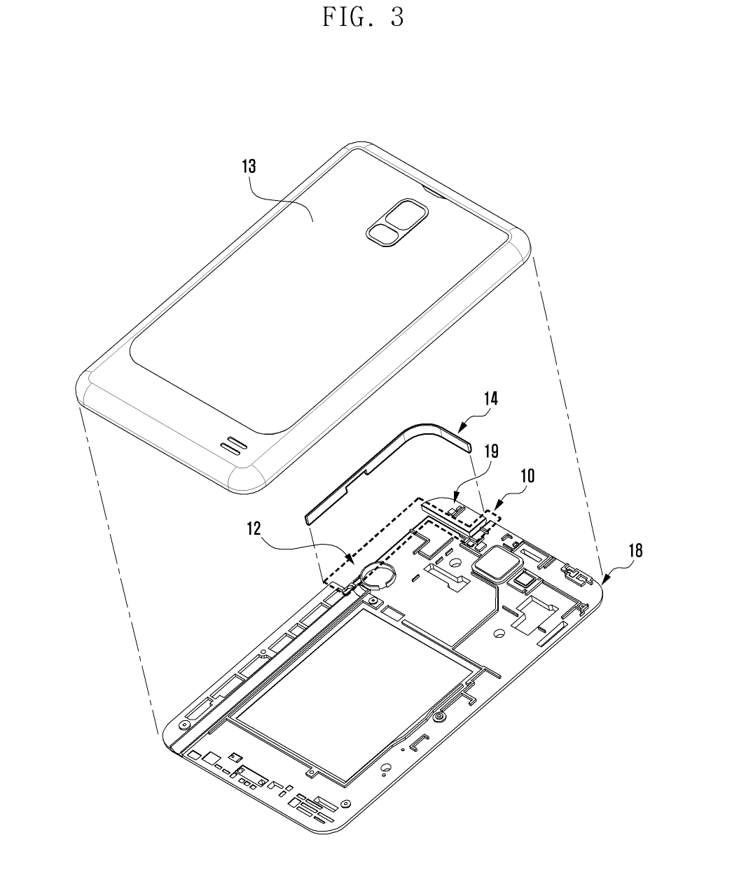

FIG. 3 is an exploded perspective view illustrating an antenna assembly structure when assembling a case, a bracket, and a metal fence of a mobile terminal according to an embodiment of the present invention.

Referring to FIG. 3, the metal fence 14 is coupled to the open slot 10 and the slot path 12 and forms a slot antenna when being assembled with a terminal case 13. The metal fence 14 electrically connects the separate bracket 19 to the bracket 18. The metal fence 14 may be positioned at the inside or the outside of the mobile terminal case 13. Further, the metal fence 14 can be formed at the inside or the outside of the mobile terminal case 13 by painting a material equivalent to a metal component inside or outside the mobile terminal case 13.

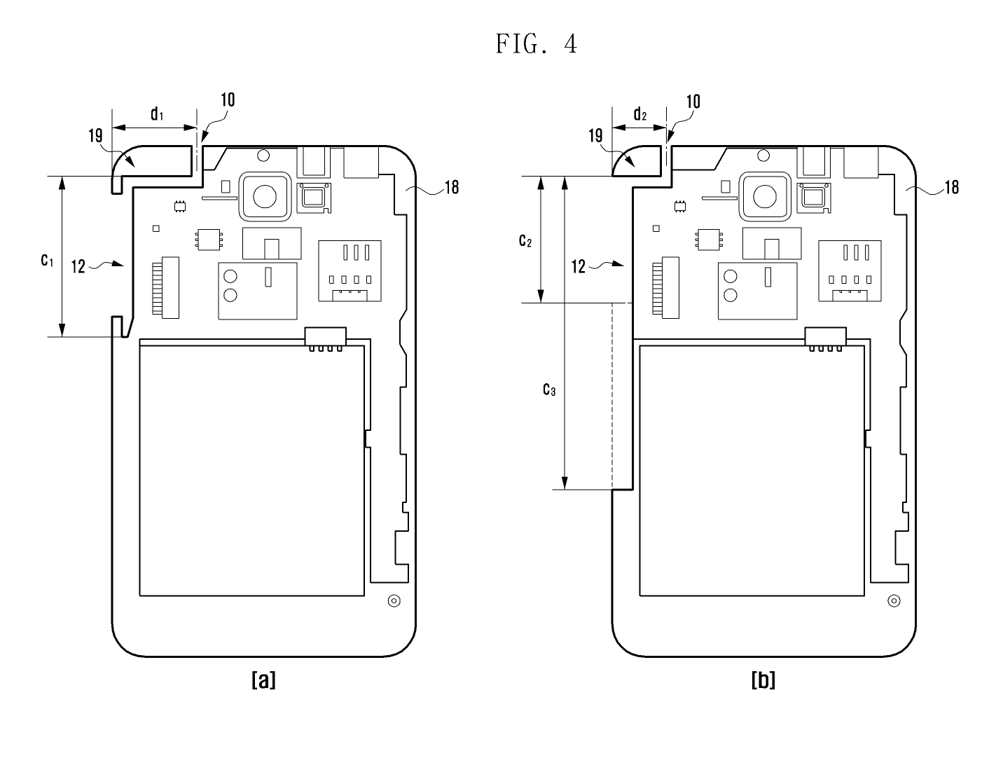

FIG. 4 illustrates various lengths and shapes of an open slot and a slot path formed in a bracket according to an embodiment of the present invention.

As shown in FIGS. 4a and 4b, a position of the open slot 10 may be changed by varying the length of bracket 19, as indicated at d₁ in FIG. 4a and at d₂ in FIG. 4b. In addition, the length of the slot path 12 may be also changed to different lengths, as shown at c₁, c₂, and c₃. The position of the open slot 10 and the length of the slot path 12 are not limited to a position and a length shown in FIG. 4 and may be varied in order to obtain a desired frequency band or to avoid frequency interference with an antenna adjacent to the slot.

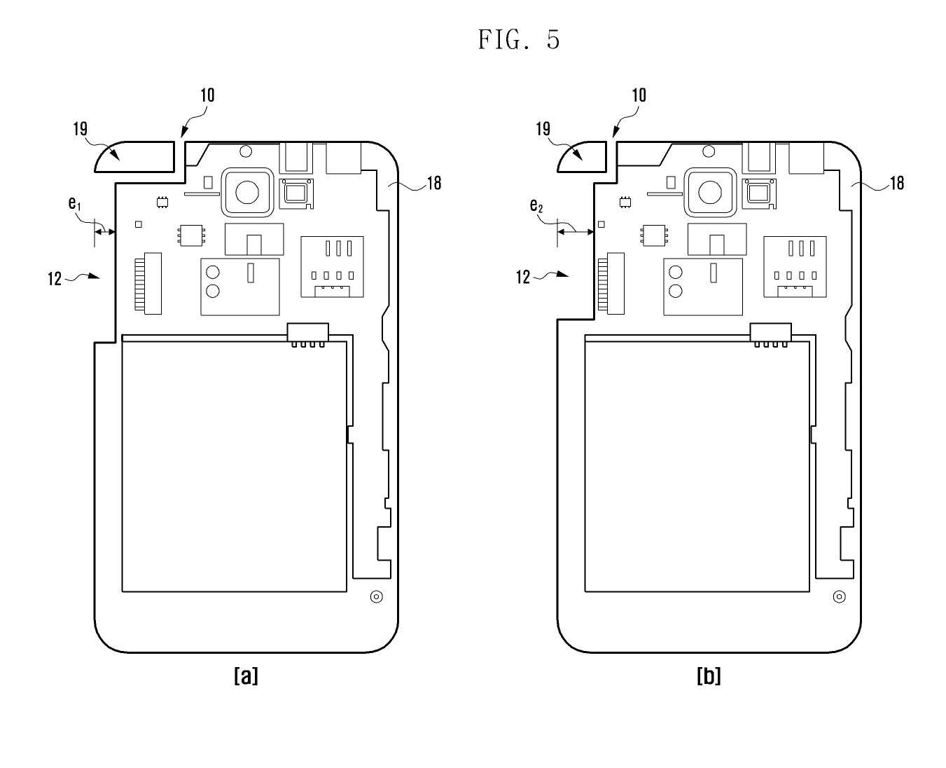

FIG. 5 illustrates a change in a position of an open slot and a size of a slot path.

As shown in FIGS. 5a and 5b, a size and/or a width of the slot path 12 may be changed, as indicated by e₁ and e₂. The width (e₂) of the slot path 12 is relatively greater than that of (e₁) of the slot path 12, and thus a surface current density in FIG. 5b increases and an antenna resonant frequency is lowered compared to that of FIG. 5a. That is, as a size of a slot increases, a surface current density flowing on an antenna radiator or a metal plate increases and an antenna resonant frequency is lowered. As such, a desired resonant frequency can be obtained according to a size and a length of a slot shown in FIGS. 5a and 5b.

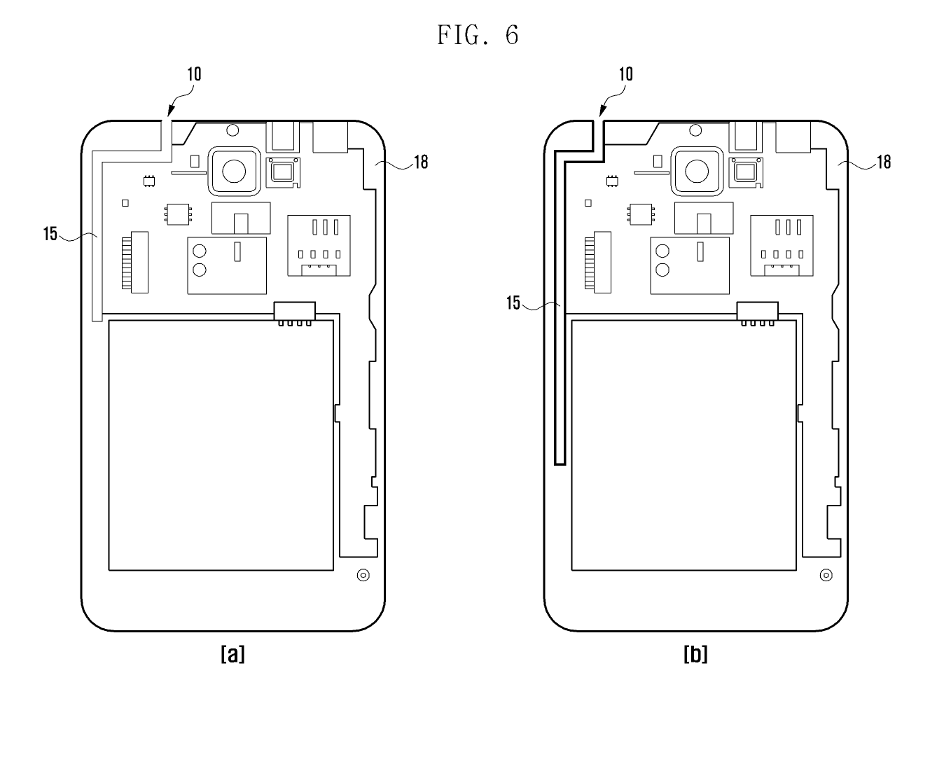

FIG. 6 illustrates various positions of an open slot and a various length and size of a slot path formed in a bracket, as necessary according to another embodiment of the present invention.

FIG. 6 illustrates another embodiment in which a slot path 15 is formed in a predetermined area of the bracket 18 without a separate bracket 19, as compared with the slot path 12 show in FIGS. 4 and 5. The length of the slot path 15 of FIG. 6a is shorter than that of the slot path 15 of FIG. 6b.

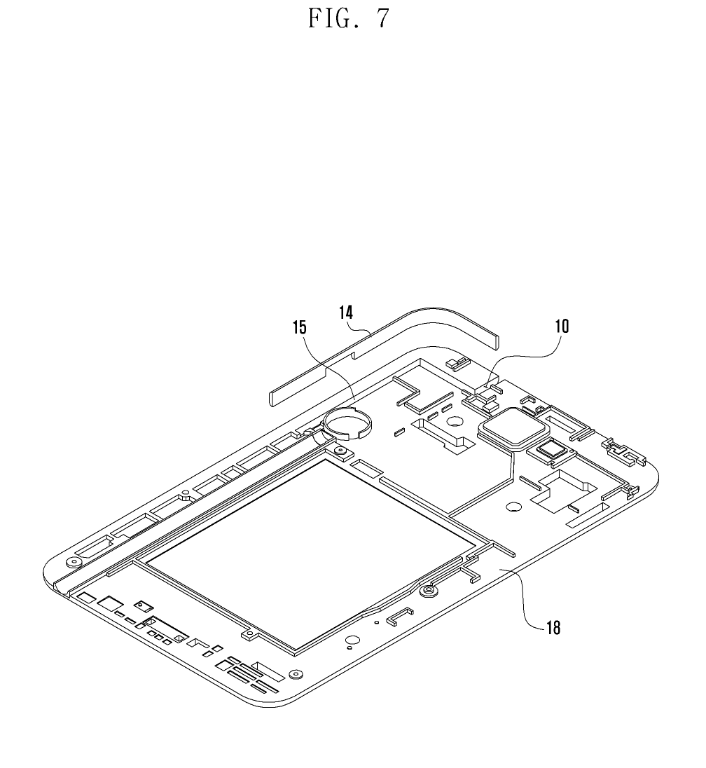

FIG. 7 is a perspective view illustrating an assembly of a bracket, slot, and metal fence according to another embodiment of the present invention.

Referring to FIG. 7, the open slot 10 and the slot path 15 exist in a predetermined area of the bracket 18 and the metal fence 14 is provided in an area adjacent to the slot. FIG. 7 is different from FIG. 2 in that the slot path 12 in FIG. 2 has an open surface of the bracket 18 and the separate bracket 19, but the slot path 15 in FIG. 7 is formed within the bracket 18, thereby not having a separate bracket 19.

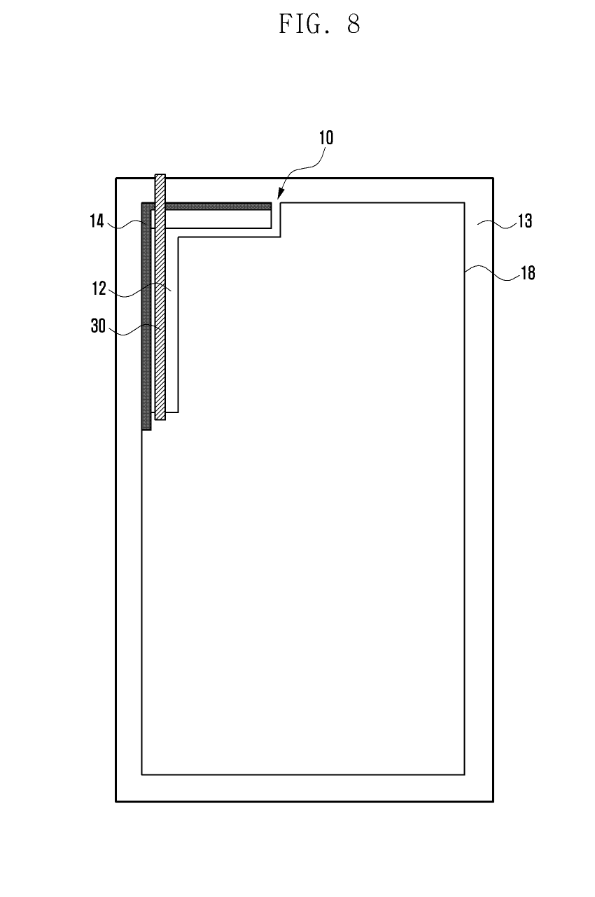

FIG. 8 illustrates an antenna adjacent to another antenna having a different frequency according to an embodiment of the present invention.

Referring to FIG. 8, an antenna (e.g., DMB antenna) 30, which has a different service frequency band from that of the second antenna, may be installed adjacent to a second antenna (e.g., a transmitting/receiving communication antenna). In this case, the second antenna may be a slot antenna formed by coupling the bracket 18, the metal fence 14, and the mobile terminal case 13 according to an embodiment of the present invention. A feeding pattern of the slot antenna generally uses an indirect feeding method using a microstrip line or a coplanar waveguide. The indirect feeding method is an electromagnetic coupling feeding method that separates a feeding line and an antenna radiator by a predetermined distance instead of directly attaching a feeding portion of an antenna to an antenna radiator and that indirectly supplies energy to an antenna radiator, through electromagnetic coupling from a feeding line.

As mentioned earlier, a desired frequency band can be obtained either by changing a position of the open slot 10 and a length of the slot path 12, and an area of an antenna in association with a surface current density or by adjusting a size of the antenna. For example, even if the antenna (e.g., DMB antenna, 3G antenna, or LTE antenna) 30 having different service frequency bands exists adjacent to the antenna (e.g., the slot antenna), the second antenna can be installed adjacent to the antenna with no or reduced frequency interference between each other. Thus, the limited space of the mobile terminal can be used effectively.

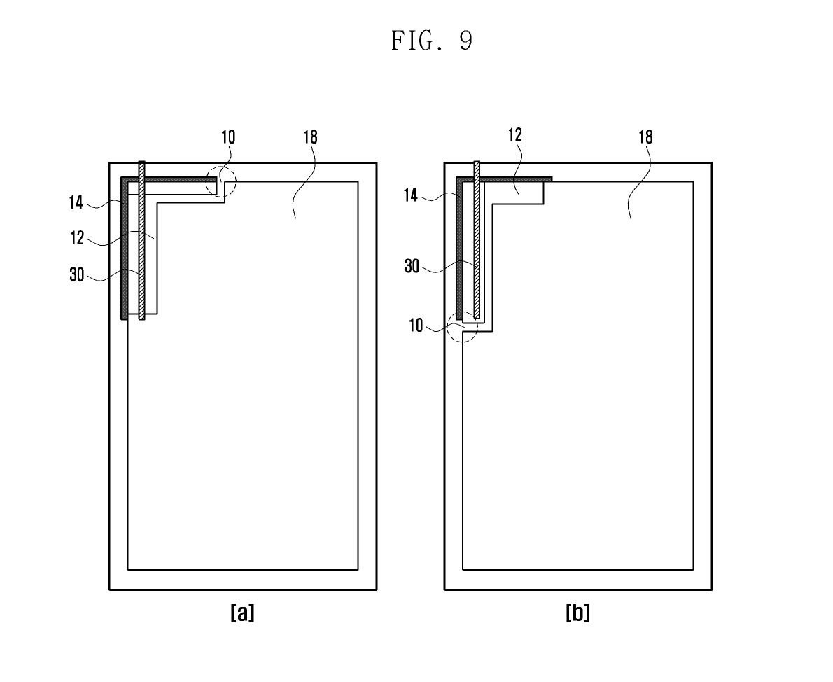

FIG. 9 illustrates various positions of an open slot according to a desired frequency band according to an embodiment of the present invention.

Referring to FIG. 9a, the open slot 10 is positioned at an upper end portion of the bracket 18, and the slot path 12 is formed with an open surface of the bracket 18. Referring to FIG. 9b, the open slot 10 is positioned at a side surface of the bracket 18, and the slot path 12 is positioned at an upper end portion. The open slot 10 and the slot path 12 are not limited to positions shown in FIG. 9. The position of the open slot 10 may be variously located, as desired.

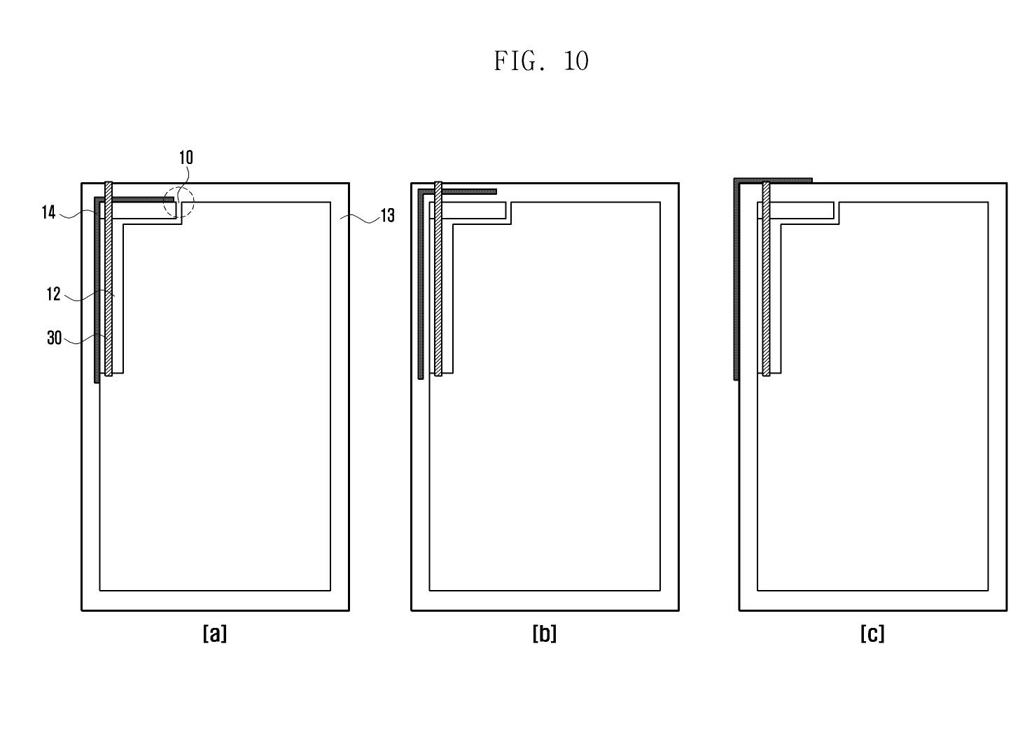

FIG. 10 illustrates an antenna structure using a distance change between a metal fence and an open slot and a slot.

In FIG. 10a, the metal fence 14 is positioned adjacent to the open slot 10 and the slot path 12 by positioning the metal fence 14 at the inside of the mobile terminal case 13. FIG. 10b illustrates an example in which the metal fence 14 is positioned at an intermediate portion of the mobile terminal case 13, and FIG. 10c illustrates an example in which the metal fence 14 is positioned at an outer surface of the mobile terminal case 13 to obtain a longer distance from the open slot 10 and the slot path 12. In other words, by adjusting the distance between the metal fence 14 and the open slot 10 and the slot path 12, a resonant frequency of an antenna can be changed and a desired frequency band can be obtained.

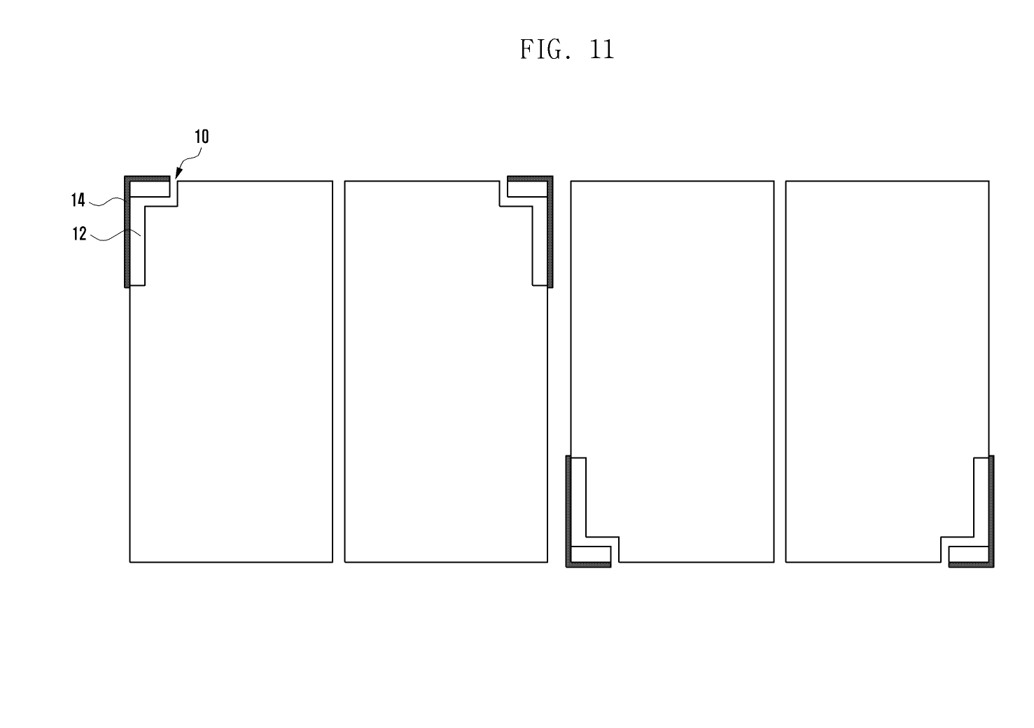

FIG. 11 illustrates an open slot, a slot path, and a metal fence that can be positioned at various locations in relation to the embodiment of FIG. 1.

Referring to FIG. 11, a position of the open slot 10, the slot path 12, and the metal fence 14 may be positioned at various locations, for example an upper end portion, a lower end portion, a left side corner, and a right side corner of the mobile terminal, as desired. A position and/or a shape of the open slot 10, the slot path 12 and the metal fence 14 is not limited to the positions shown in FIG. 11.

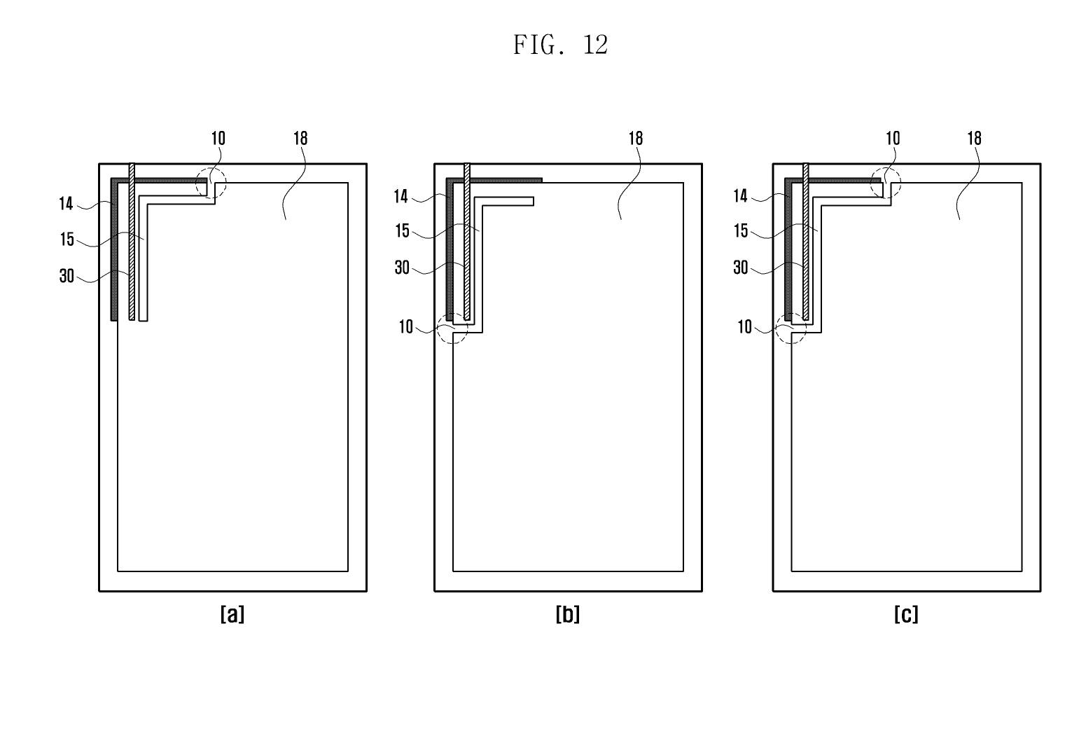

FIG. 12 illustrates various positions of an open slot according to a desired frequency band according to an embodiment of the present invention.

Referring to FIGS. 12a and 12b, the open slot 10 may be positioned at an upper end portion of the bracket 18 or at a side surface of the bracket 18, respectively. Further, FIG. 12c illustrates that two or more open slots 10 may be positioned and used at an upper end portion and a side surface. A position of the open slot 10 is not limited to the position shown in FIG. 12. The position may be variously set according to an antenna position of a mobile terminal and/or positions of other components mounted on the mobile terminal. With regard to the one or more open slots, multiple resonances can be created due to two modes generated by the multiple open slots 10.

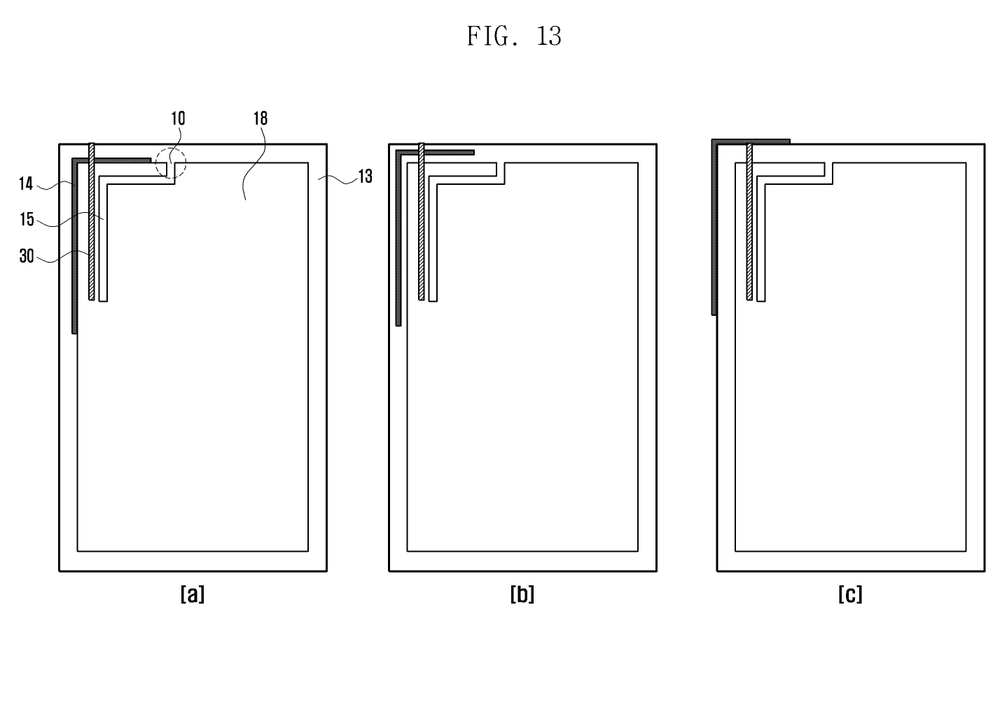

FIG. 13 illustrates an antenna structure using a distance change between a metal fence and an open slot and a slot path in relation to the embodiment of FIG. 6, according to an embodiment of the present invention.

In FIG. 13a, the metal fence 14 is positioned adjacent to the open slot 10 and the slot path 15 by positioning the metal fence 14 at the inside of the mobile terminal case 13. FIG. 13b illustrates an example in which the metal fence 14 is positioned at an intermediate portion of the mobile terminal case 13, and FIG. 13c illustrates an example in which the metal fence 14 is positioned at an outer surface of the mobile terminal case 13 to obtain a longer distance from the open slot 10 and the slot path 15. In other words, by adjusting the distance between the metal fence 14 and the open slot 10 and the slot path 15, a resonant frequency of an antenna can be changed and a desired frequency band can be obtained.

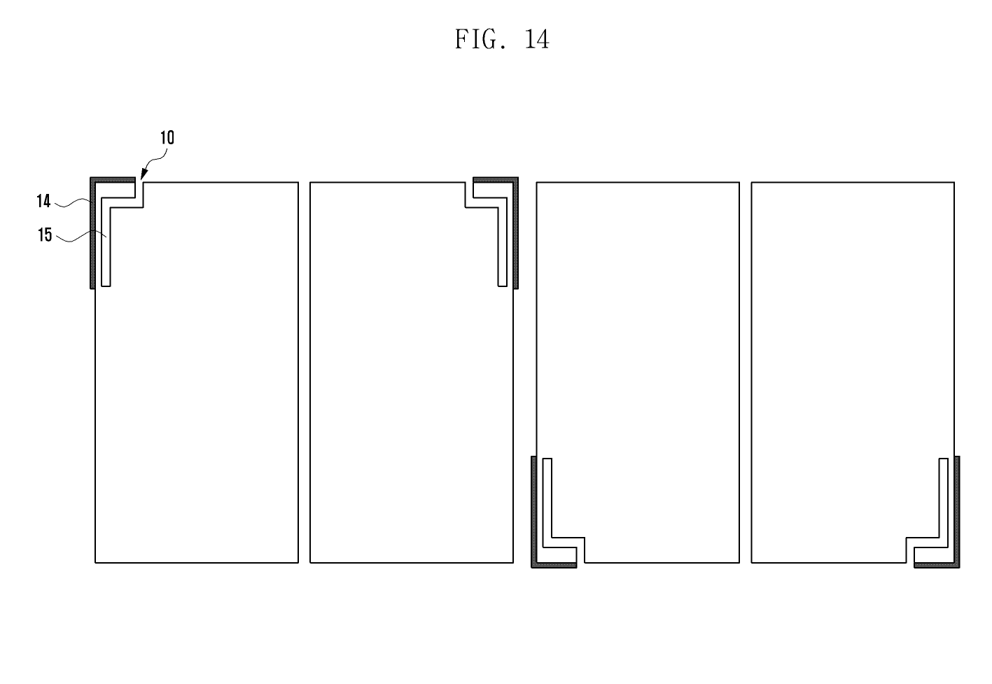

FIG. 14 illustrates an open slot, a slot path, and a metal fence that can be positioned at various locations in relation to the embodiment of FIG. 4.

Referring to FIG. 14, a position of the open slot 10, the slot path 15, and the metal fence 14 may be positioned at various locations, for example an upper end portion, a lower end portion, a left side corner, and a right side corner of the mobile terminal, as desired. A position and/or a shape of the open slot 10, the slot path 15 and the metal fence 14 is not limited to the positions shown in FIG. 14.

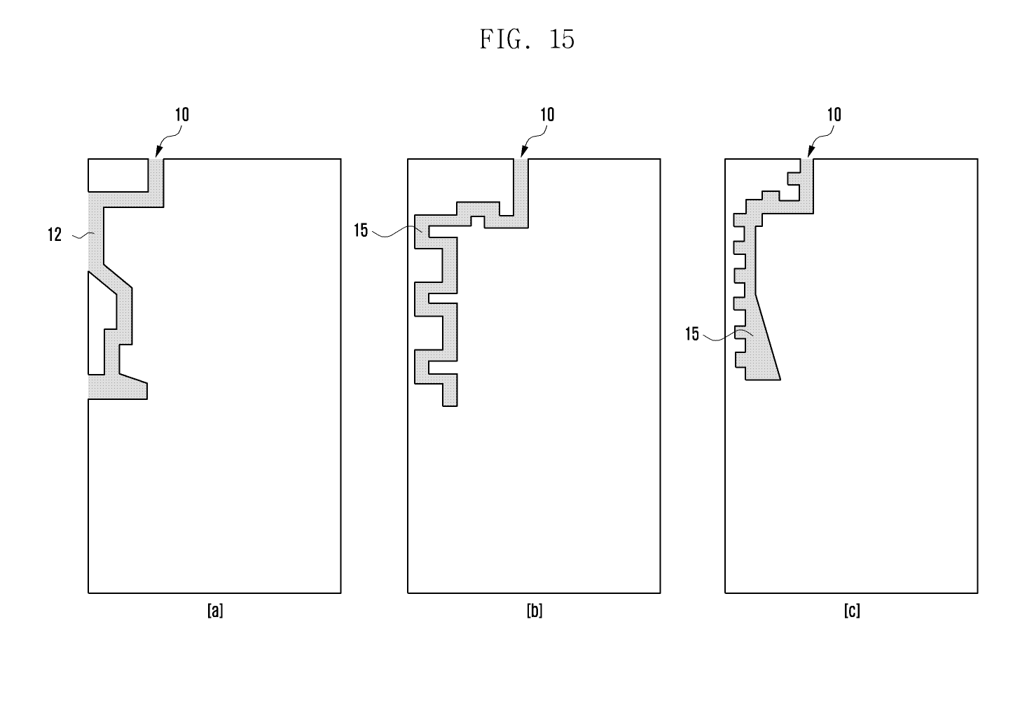

FIG. 15 illustrates a change in a shape and a length of a slot path according to an embodiment of the present invention.

Referring to FIG. 15, in order to avoid frequency interference with a peripheral antenna and to obtain a desired frequency band, a position of the open slot 10 and a shape of the slot paths 12 and 15 may be changed, as desired.

According to embodiments of the present invention, a mobile terminal with several antennas having different service frequencies reduces antenna performance deterioration due to frequency interference or electromagnetic interference because multiple antennas can be installed at a region adjacent to other antennas having different frequency bands.

Although certain embodiments of the present invention have been described in detail hereinabove, it should be clearly understood that many variations and modifications of the basic inventive concepts herein described, which may appear to those skilled in the art, will still fall within the spirit and scope of the embodiments of the present invention as defined in the appended claims.

What is claimed is:

1. An antenna in a mobile terminal, comprising:
a slot formed in a mobile terminal by assembling a mobile terminal case and a metal structure, wherein the metal structure comprises a bracket and the slot is formed at one side of the bracket;
a metal fence positioned at a side surface adjacent to the metal structure and the slot; and
a feeding pattern for supplying power to the antenna.

2. The antenna of claim 1, wherein the antenna is installed adjacent to another antenna having a different service frequency band.

3. The antenna of claim 2, wherein the another antenna comprises one of a DMB antenna and a broadcasting service band antenna.

4. The antenna of claim 1. wherein the slot is formed in various shapes, lengths, and widths to provide different frequency service bands, according to a desired frequency service band.

5. The antenna of claim 1, wherein the metal fence is positioned at one of positions including adjacent to the metal structure, at the inside of the mobile terminal case, and at the outside of the mobile terminal case.

6. The antenna of claim 1, wherein a distance between the slot and the metal fence is adjusted according to a desired frequency service band.

7. The antenna of claim 1, wherein the metal fence is a metal frame positioned between the bracket and the mobile terminal case.

8. The antenna of claim 1, wherein the metal fence is formed by painting a metal material to an inner surface of the mobile terminal case.

9. The antenna of claim 1, wherein the slot, the metal fence, and the feeding pattern are formed in an area corresponding to an edge of the mobile terminal.

10. The antenna of claim 1, wherein the feeding pattern is formed parallel to the slot or is disposed across from the slot, using one of an indirect feeding method and a direct feeding method.
